(19) United States
(12) Patent Application Publication
(10) Pub. No.: US 2022/0088800 A1
(43) Pub. Date: Mar. 24, 2022

(54) HYBRID GRIPPER FOR HANDLING OBJECTS

(71) Applicant: GREY ORANGE PTE. LTD., Singapore (SG)

(72) Inventors: Akash Madhukar Patil, Pune (IN); Andreas Hofmann, Boston, MA (US); Daniel Echeverria, Cambridge, MA (US); Manish Soni, Baran (IN); Mathew Livianu, Malden, MA (US); Sameer Narkar, Mumbai (IN); Shawn Schaffert, Arlington, MA (US); Sumit Kumar Tiwary, Gorakhpur (U.P.) (IN)

(73) Assignee: GREY ORANGE PTE. LTD., Singapore (SG)

(21) Appl. No.: 17/448,832

(22) Filed: Sep. 24, 2021

(30) Foreign Application Priority Data
Sep. 24, 2020 (IN) 202011041493

(51) Int. Cl. B25J 15/06; B25J 15/00; B25J 15/02; B25J 9/16; B25J 13/08

(52) U.S. Cl. CPC B25J 15/0616; B25J 15/0014; B25J 15/0052; B25J 13/088; B25J 9/1612; B25J 9/1697; B25J 15/02

(57) ABSTRACT

A hybrid gripper that is used as end effector of a robotic manipulator for handling objects that are arranged in top, middle, and bottom shelves of a storage unit. The hybrid gripper may include first and second end effectors, where the first end effector is pivotally coupled to the second end effector. The first end effector includes a first longitudinal support member and an axle member that telescopically moves in and out of the first longitudinal support member. The axle member is attached to a gripper assembly that houses first and second suction cups to grip and pick the objects. The second end effector includes a second longitudinal support member and a spatula that is rotatably attached to the second longitudinal support member. Here, the spatula and the first longitudinal support member move relative to the second longitudinal support member.

### CROSS-REFERENCE TO RELATED APPLICATIONS

This application claims priority to Indian Patent Application No. 202011041493, filed on Sep. 24, 2020. The entire contents of the foregoing application is incorporated herein by reference.

### FIELD OF THE DISCLOSURE

The present disclosure relates generally to object handling, and more particularly, to an apparatus for handling objects in a storage facility.

### BACKGROUND

Modern storage facilities handle a large number of inventory items on a daily basis. Examples of such inventory items may include groceries, apparels, or the like. The storage facilities typically store the inventory items on shelves or bins of storage units, and utilize mobile robots to transport the inventory items or the storage units between various locations in the storage facilities for order fulfilment and/or inventory management. For example, for fulfilment of an order, the mobile robots may transport one or more storage units storing the corresponding inventory items to an operation station in the storage facility. At the operation station, an operator may handle (i.e., pick and put-down) the inventory items for the order fulfilment. Such systems, however, rely on manual intervention which is time-consuming. Further, manual operation has limited applicability in a large-scale facility that aims to fulfil a large number of orders within a short duration of time.

Robotic manipulators are widely deployed in the storage facilities to solve the aforementioned problem and to ensure efficient management of the inventory items. While the robotic manipulators provide efficient handling of inventory items, they have few limitations of their own. For example, when the existing end effectors of such robotic manipulators are utilized to handle objects that are arranged in a stack, the robotic manipulators may have to use two or more robotic arms to ensure effective handling of the objects without deformation of the stack. The robotic manipulators with two or more robotic arms are difficult to control and operate in comparison to the robotic manipulators with one robotic arm. However, the existing robotic manipulators with one robotic arm are unable to pick up the objects that are arranged in the stack while maintaining original form factors of the object (i.e., a form factor in which the object was stored originally) and the rest of the stack.

U.S. granted Pat. No. 10,335,956 discloses a robotic manipulator with a single robotic arm to handle objects. The robotic arm has two end effectors, namely a vacuum cup and a base. However, the proposed design of the cited patent fails to selectively pick objects from both lower and upper bins of the storage unit. In other words, in an attempt to grasp a particular object from either of the upper or lower bins, the robotic system needs to have end effectors that can flexibly move around to effectively pick objects from any bin of the storage unit.

In light of the foregoing, there exists a need for end effectors that may pick objects from any bin of storage units while preventing deformation of objects and corresponding stack.

### SUMMARY

In an embodiment of the present disclosure, a robotic manipulator comprising a robotic arm and a hybrid gripper coupled to the robotic arm is disclosed. The hybrid gripper may be used as end effector of the robotic manipulator. The hybrid gripper may be used for handling objects that are arranged in top, middle, and bottom shelves of a storage unit. The robotic arm may orient the hybrid gripper with respect to an object positioned in one of the top, middle, and bottom shelves of the storage unit. The hybrid gripper may include a first end effector that has a first longitudinal support member, a gripper assembly, and a linear actuator attached to the first longitudinal support member and the gripper assembly. The linear actuator provides axial movement to the gripper assembly with respect to the first longitudinal support member. The gripper assembly grips and picks the object positioned at a first height. The hybrid gripper may further include a second end effector pivotably coupled to the first end effector. The second end effector may include a second longitudinal support member and a spatula, rotatably coupled to an end of the second longitudinal support member, to hold the object picked by the gripper assembly. The hybrid gripper may further include a drive assembly that is coupled to the first longitudinal support member and the second longitudinal support member to provide angular movement to the first longitudinal support member with respect to the second longitudinal support member. A rotating mechanism is coupled to the second longitudinal support member and the spatula to provide angular movement to the spatula with respect to the second longitudinal support member. The angular movement of the first longitudinal member and the spatula with respect to the second longitudinal support member and the axial movement of the gripper assembly with respect to the first longitudinal support member allow the hybrid gripper to handle objects positioned at a plurality of heights.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment, in accordance with an exemplary embodiment of the present disclosure;

FIG. 2 is a perspective view of a robotic manipulator of FIG. 1, in accordance with an exemplary embodiment of the present disclosure;

FIG. 3A is a side view of a hybrid gripper of FIG. 1, in accordance with an exemplary embodiment of the present disclosure;

FIG. 3B is an enlarged view of a first end of the hybrid gripper of FIG. 1, in accordance with an exemplary embodiment of the present disclosure;

FIG. 3C is a top view of the hybrid gripper of FIG. 1, in accordance with an exemplary embodiment of the present disclosure;

FIG. 3D is an enlarged view of a second end of the hybrid gripper of FIG. 1, in accordance with an exemplary embodiment of the present disclosure;

FIG. 3E is a perspective view of a gripper assembly of the hybrid gripper of FIG. 1, in accordance with an exemplary embodiment of the present disclosure;

FIG. 3F is a perspective view of a spatula of the hybrid gripper of FIG. 1, in accordance with an exemplary embodiment of the present disclosure;

FIGS. 4A-4D, collectively illustrate an exemplary scenario for handling an object that is arranged in a stack by the hybrid gripper, in accordance with an exemplary embodiment of the present disclosure;

FIG. 5 is a block diagram that illustrates a control server of FIG. 1, in accordance with an exemplary embodiment of the present disclosure; and

FIGS. 6A-6C, collectively represent a flow chart 600 that illustrates a process (i.e., a method) for handling an object by the hybrid gripper, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the disclosure provide a hybrid gripper to be used as an end effector for a robotic system or a robotic manipulator. The hybrid gripper may be attached to one of a plurality of robotic arms of the robotic system to efficiently handle objects in a storage facility. Examples of the storage facility may include a retail store, a forward warehouse, a backward warehouse, a manufacturing facility, or the like. The storage facility may include various storage units installed therein, and each storage unit may have various shelves or bins where the objects may be arranged in stacks or placed individually. Here, the storage units may be mobile storage units. Examples of the objects may include plastic packages, apparels, sheets, paper, cartons, or the like. The hybrid gripper may include first and second end effectors that move relative to each other. According to some embodiments, the first end effector is pivotably coupled to the second end effector. The first end effector has a first longitudinal support member, a gripper assembly, and a linear actuator attached to the first longitudinal support member and the gripper assembly. The linear actuator provides axial movement to the gripper assembly with respect to the first longitudinal support member. The gripper assembly grips and picks the object. The linear actuator allows the gripper assembly to change its position in a longitudinal direction, thus providing flexibility for the operation of the hybrid gripper. According to some embodiments, thesecond end effector includes a second longitudinal support member and a spatula that is pivotably attached to the second longitudinal support member. The spatula is pivoted to the second longitudinal support member through a rotating mechanism. The rotating mechanism allows the spatula to change its angular position with respect to the second longitudinal support member.

The first longitudinal support member is pivoted to the second longitudinal support member through a drive assembly. The drive assembly allows the first longitudinal support member to move in an angular direction with respect to the second longitudinal support member according to the requirement of the operation to be performed. Moreover, the longitudinal movement of the gripper assembly is controlled via the linear actuator. Thus, the hybrid gripper provides more flexibility to handle objects placed in different bins of the storage unit irrespective of the height of the bins from a floor level. The first end effector may include a camera installed on the drive shaft so as to identify the geographical orientation of the objects to be handled during PICK and PUT operation. The first end effector may stay in operation until the object has been dropped/placed to its specified location. One or more sensors (such as load sensors, infrared sensors, pressure sensors, touch sensors, or the like) are placed or installed on the spatula to detect presence of an object on the spatula.

A control server associated with the storage facility may receive a handling request for handling an object positioned in one of the bins of the storage unit or any other platform of the storage facility. Upon reception of the handling request, the control server may communicate a source location of a first object (i.e., a store keeping unit, SKU) to the hybrid gripper of the robotic system. As the hybrid gripper approaches the bin of the storage unit based on the source location, the camera on the hybrid gripper allows an identification of an orientation of the first object and position of the first object in the storage unit. Upon determination of the orientation of the first object and height at which the object is positioned in the storage unit, the control server may determine a plurality of actions to be performed by the hybrid gripper of the robotic system to handle the first object while maintaining a form factor of the first object and the remaining stack. The control server may determine the plurality of actions in real-time based on the location of the bin, height of the bin, the orientation of the first object, and a set of physical attributes of the first object. Upon reception of a set of commands indicating the plurality of actions from the control server, the first and second end effectors are operated to handle the first object.

Thus, the hybrid gripper of the disclosure, in conjunction with the control server, ensures that the robotic system effectively picks objects from any bin of the storage unit. Further, the use of the spatula-shaped end effector ensures that the remaining objects in the stack are unaffected during the handling of the first object. Moreover, the control server controls the angular movement of the spatula and the first longitudinal support member, and the axial movement of the gripper assembly to pick objects positioned at different heights in the storage unit. Thus, the handling of the objects in the upper and lower bins of the storage unit as described in the disclosure is more efficient as compared to conventional object handling methods.

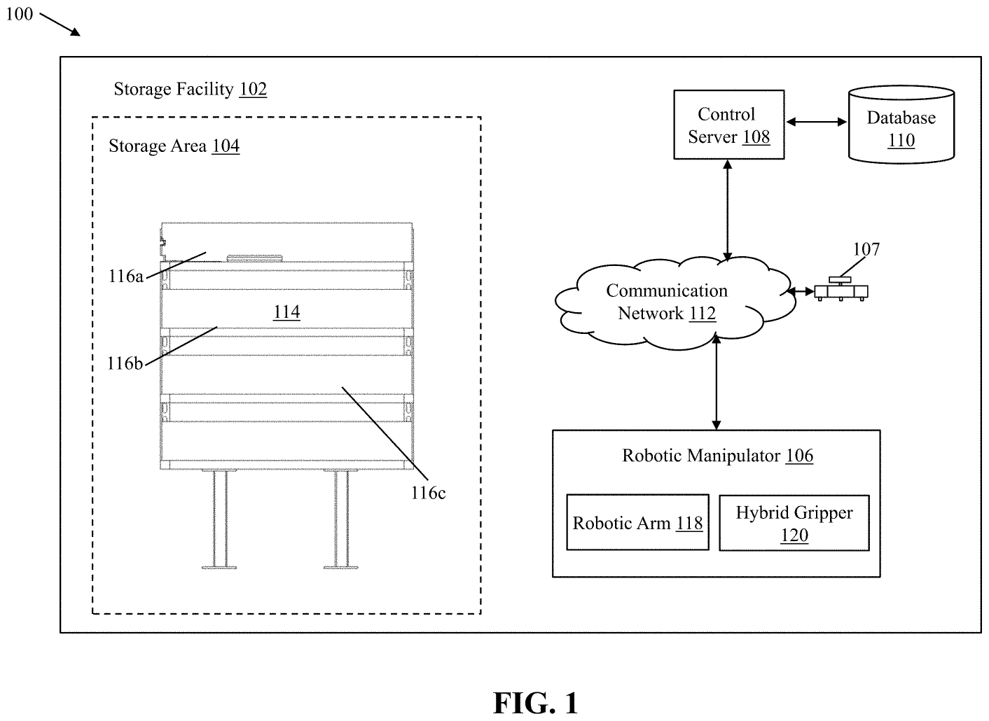

FIG. 1 is a block diagram that illustrates an embodiment of an exemplary environment 100, in accordance with an exemplary embodiment of the present disclosure. The environment 100 shows a storage facility 102. The storage facility 102 includes a storage area 104, a robotic manipulator 106, a control server 108, and a database 110. The control server 108 communicates with the robotic manipulator 106 by way of a communication network 112 or through separate communication networks established therebetween.

The storage facility 102 stores multiple inventory items for fulfillment and/or selling. Examples of the storage facility 102 may include, but are not limited to, a forward warehouse, a backward warehouse, a manufacturing facility, an item sorting facility, or a retail store (e.g., a supermarket, an apparel store, or the like). The inventory items include objects such as packages, apparels, sheets, cartons, or the like, and are stored in the storage area 104 of the storage facility 102. The storage area 104 may be of any shape, for example, a rectangular shape.

The storage area 104 includes a plurality of storage units (e.g., a storage unit 114) for storing the objects. Examples of the storage unit 114 may include, but are not limited to, multi-tier racks, pallet racks, portable mezzanine floors, vertical lift modules, horizontal carousels, or vertical carousels. In an embodiment, the storage unit 114 may correspond to mobile storage units that are movable from one location to another location in the storage facility 102. In such a scenario, the movement of the storage unit 114 may be enabled by a mobile robot 107 or any other mechanism known in the art.

The storage unit 114 includes various shelves (or bins), and each shelf may be empty or may store the objects in a stack or individually. For example, the storage unit 114 includes a top shelf 116a, a middle shelf 116b, and a bottom shelf 116c that store various objects. The storage facility 102 may be marked with various fiducial markers. Examples of the fiducial markers may include, but or not limited to, barcodes, quick response (QR) codes, radio frequency identification device (RFID) tags, or the like. The mobile robot 107 may be configured to read the fiducial markers for their movement.

The robotic manipulator 106 may include suitable logic, instructions, circuitry, interfaces, and/or code, executable by the circuitry, for executing various operations, such as handling objects that may or may not be arranged in stacks. Handling of an object may correspond to one of adjusting an alignment of the object in the stack and transporting the object from a source location to a destination location in the storage facility 102. For example, the object may be transported from an operation station (i.e., pick-and-put station, PPS) to a shelf (e.g., a bin) of a storage unit. In another example, the object may be transported from a shelf of a storage unit to another shelf of the same storage unit, to a shelf of another storage unit, or to the operation station. The storage unit 114 is transported to a location that is within an operational range of the robotic manipulator 106 by the mobile robot 107. In one example, the robotic manipulator 106 may be deployed in a vicinity of the operation station.

The robotic manipulator 106 may include one or more robotic arms. Herein, according to some embodiments, the robotic manipulator 106 has a robotic arm 118 and a hybrid gripper 120 (i.e., an end effector) connected to the robotic arm 118 for facilitating handling of the objects. To handle an object, the robotic manipulator 106 may execute a pick operation on the object, followed by a put-down operation. The pick operation corresponds to gripping and partially lifting the object by way of one end effector of the hybrid gripper 120, and holding and lifting the partially lifted object in entirety by way of another end effector of the hybrid gripper 120. The put-down operation corresponds to placing the lifted object at a destination location.

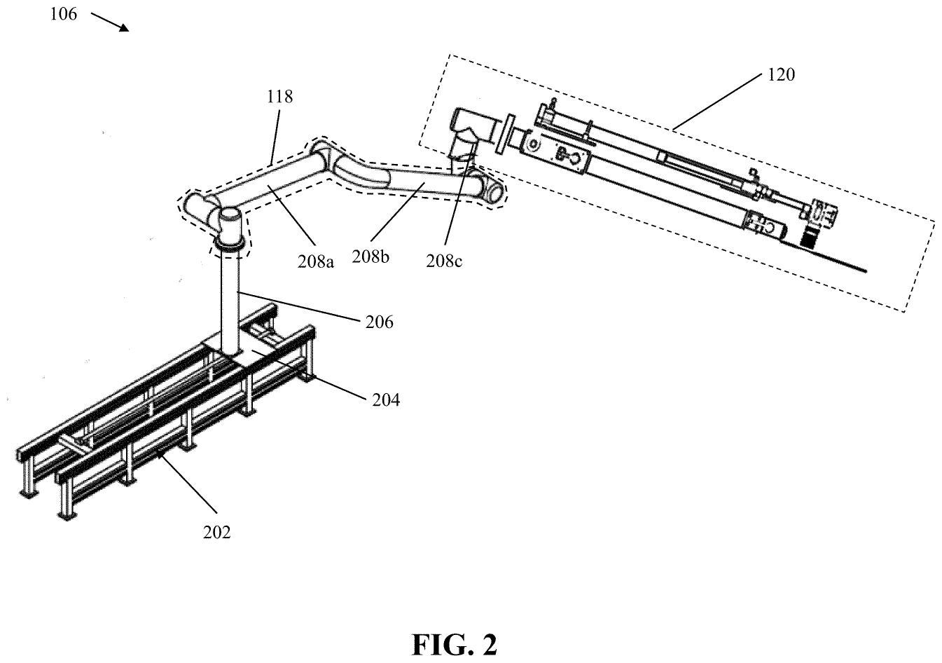

The robotic manipulator 106 receives various commands from the control server 108 for handling the object, and under the control of the received commands, the robotic manipulator 106 executes the handling of the object. For example, the robotic manipulator 106 may receive various commands from the control server 108 to place an object at the platform of the operation station, on a shelf. Under the control of the received commands, the robotic manipulator 106 may pick the object from the stack, and put down the picked object on the shelf. Embodiments of various components of the robotic manipulator 106 are explained in detail in conjunction with FIG. 2.

According to some embodiments, the mobile robot 107 is a robotic device (for example, an autonomous mobile robot (AMR), an autonomous guided vehicle (AGV), or a combination thereof) in the storage facility 102. The mobile robot 107 may include suitable logic, instructions, circuitry, interfaces, and/or codes, executable by the circuitry, for automatically transporting payloads (e.g., the storage unit 114) in the storage facility 102 based on commands received from the control server 108. For example, the mobile robot 107 may carry and transport the storage unit 114 from the storage area 104 to the operation station. The mobile robot 107 may include various sensors (e.g., image sensors, RFID sensors, and/or the like) for determining a relative position thereof within the storage facility 102 and/or identifying the storage unit 114.

According to some embodiments, the control server 108 is a network of computers, a software framework, or a combination thereof, that may provide a generalized approach to create the server implementation. Examples of the control server 108 may include, but are not limited to, personal computers, laptops, mini-computers, mainframe computers, any non-transient and tangible machine that can execute a machine-readable code, cloud-based servers, distributed server networks, or a network of computer systems. The control server 108 may be realized through various web-based technologies such as, but not limited to, a Java web-framework, a .NET framework, a personal home page (PHP) framework, or any other web-application framework.

In some embodiments, the control server 108 may be a physical or cloud data processing system on which a server program runs. The control server 108 may be implemented in hardware or software, or a combination thereof. In one embodiment, the control server 108 may be implemented in computer programs executing on programmable computers, such as personal computers, laptops, or a network of computer systems.

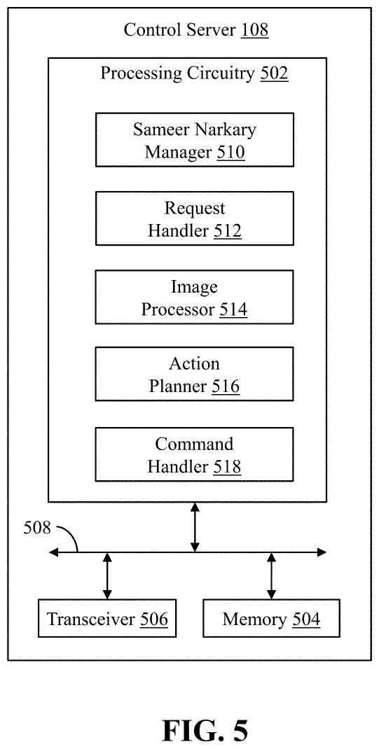

The control server 108 may be configured to implement a goods-to-person (GTP) setup in the storage facility 102, where the storage unit 114 storing different inventory items are picked up from the storage area 104 and transported to the operation station. The control server 108 may be further configured to control execution of different operations associated with replenishment of the storage unit 114, an order sorting operation, palletization and/or de-palletization of inventory items, or the like. The control server 108 may be maintained by a warehouse management authority or a third-party entity that facilitates inventory management operations for the storage facility 102. Embodiments of various components of the control server 108 and their functionalities are described later in conjunction with FIG. 5.

The control server 108 may receive, from a management server at the storage facility 102, a handling request for handling an object that is arranged in a stack. The handling request may be associated with an order fulfilment, an inventory management operation, or the like. The handling request may include a source location of the object, a destination location of the object, fiducial markers of shelves associated with the source and/or destination locations, a unique identifier of the object, or the like. In various other embodiments, the functionalities of the management server may be integrated into the control server 108, without deviating from the scope of the disclosure. In such a scenario, the source and destination locations, the fiducial markers, the unique identifier, or the like, are identified by the control server 108 for the order fulfilment, the inventory management operation, or the like. The control server 108 may communicate the source and destination locations to the robotic manipulator 106.

According to some embodiments, the database 110 may include suitable logic, instructions, circuitry, interfaces, and/or code to store historical data and a set of commands corresponding to a plurality of actions planned by the control server 108 for object handling. Examples of the database 110 may include a random-access memory (RAM), a read-only memory (ROM), a removable storage drive, a hard disk drive (HDD), a flash memory, a solid-state memory, and the like. In one embodiment, the database 110 may be realized through various database technologies such as, but not limited to, Microsoft® SQL, Oracle®, IBM DB2®, Microsoft Access®, PostgreSQL®, MySQL° and SQLite®. It will be apparent to a person skilled in the art that the scope of the disclosure is not limited to realizing the database 110 in form of an external database or a cloud storage working in conjunction with the control server 108, as described herein. In other embodiments, the database 110 may be realized in the control server 108, without departing from the scope of the disclosure.

According to some embodiments, the communication network 112 is a medium (for example, multiple network ports and communication channels) through which content and messages are transmitted between the robotic manipulator 106 and the control server 108. Examples of the communication network 112 may include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 112 in accordance with various wired and wireless communication protocols, such as Transmission Control Protocol and Internet Protocol (TCP/IP), User Datagram Protocol (UDP), Long Term Evolution (LTE) communication protocols, Hypertext Transfer Protocol (HTTP), File Transfer Protocol (FTP), Simple Mail Transfer Protocol (SMTP), Domain Network System (DNS), Common Management Interface Protocol (CMIP), or any combination thereof.

Thus, FIG. 1 describes a system for handling objects that are arranged in shelves or bins or positioned at different working platforms in the storage facility 102. In one embodiment, the system may include only the control server 108 that controls the robotic manipulator 106 for handling the objects positioned at different heights in the storage unit 114.

FIG. 2 is a perspective view of the robotic manipulator 106, in accordance with an exemplary embodiment of the present disclosure. The robotic manipulator 106 may include a guide rail 202 having a carriage 204 mounted thereon. The carriage 204 supports a column 206. The carriage 204 is affixed at one end of the column 206 and the robotic arm 118 is mounted on the opposite end of the column 206.

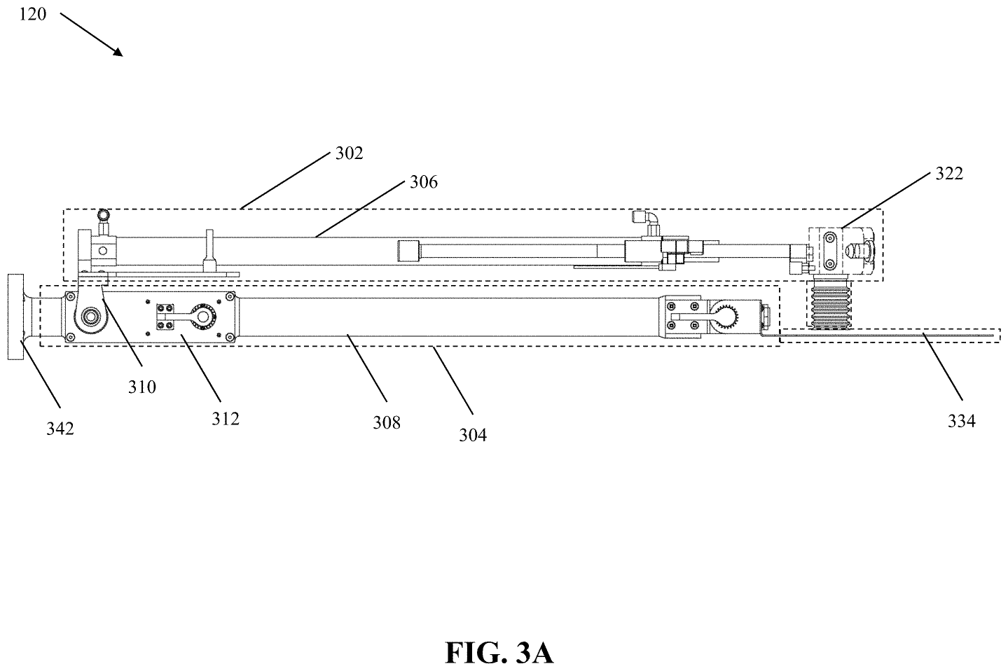

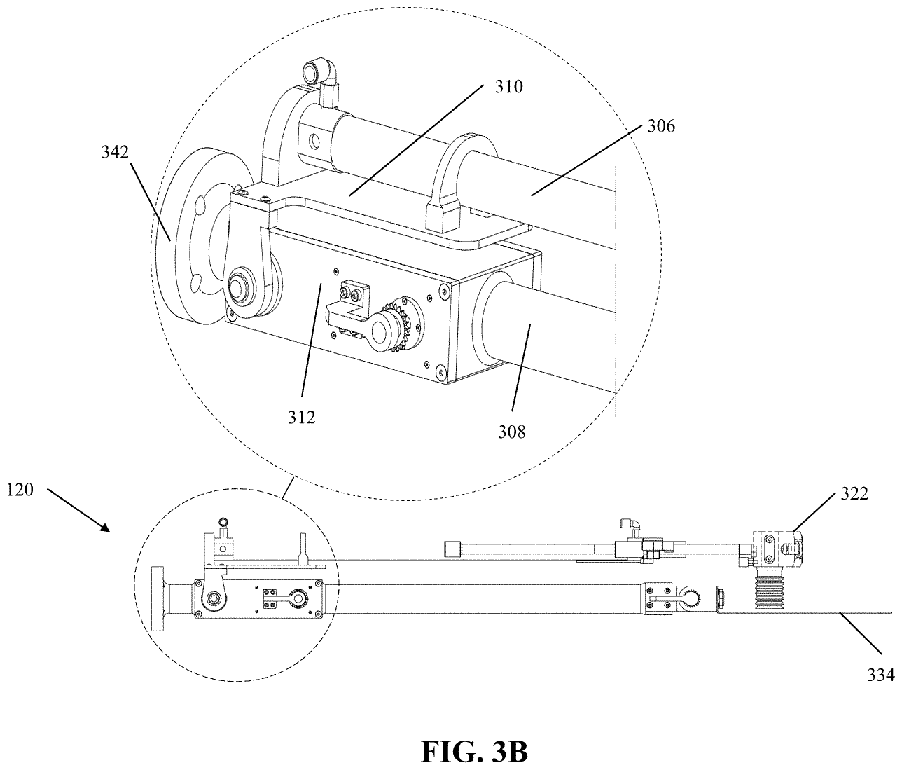

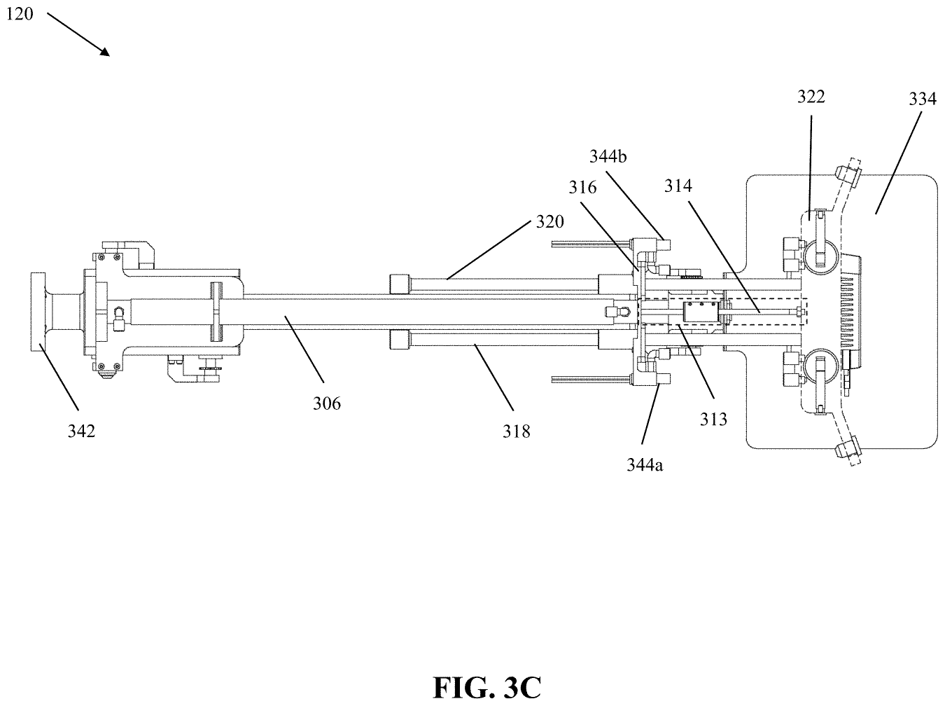

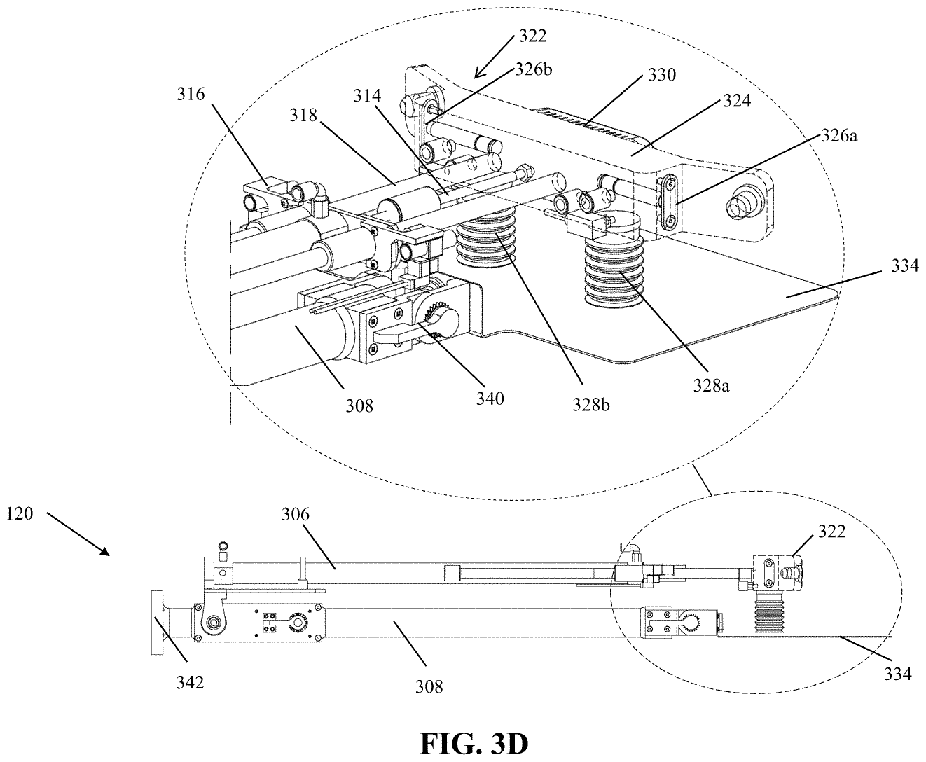

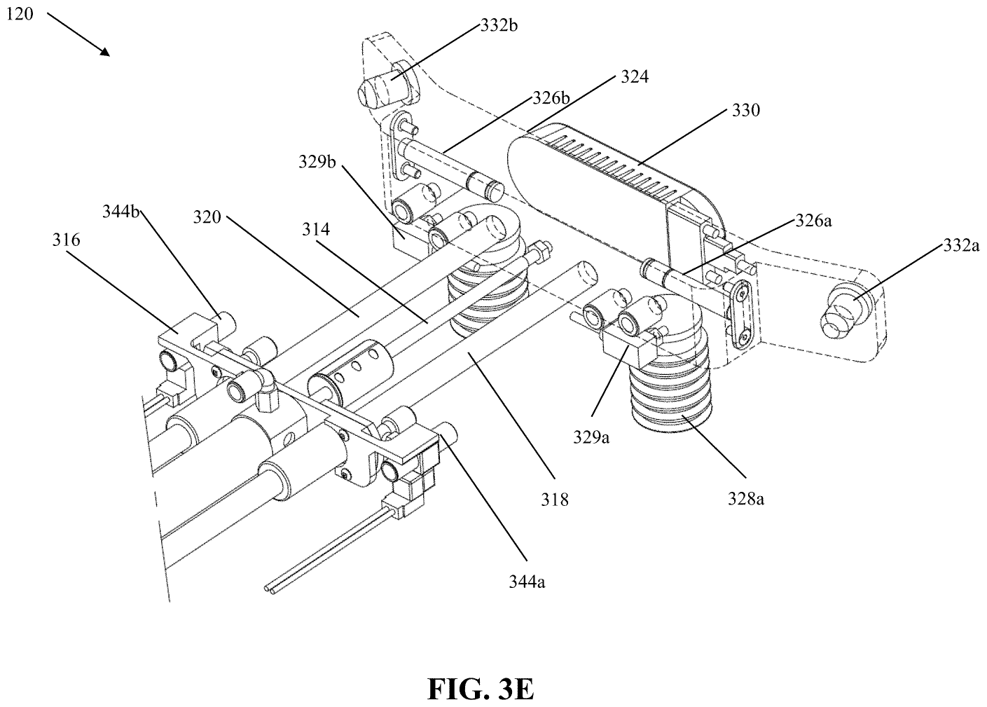

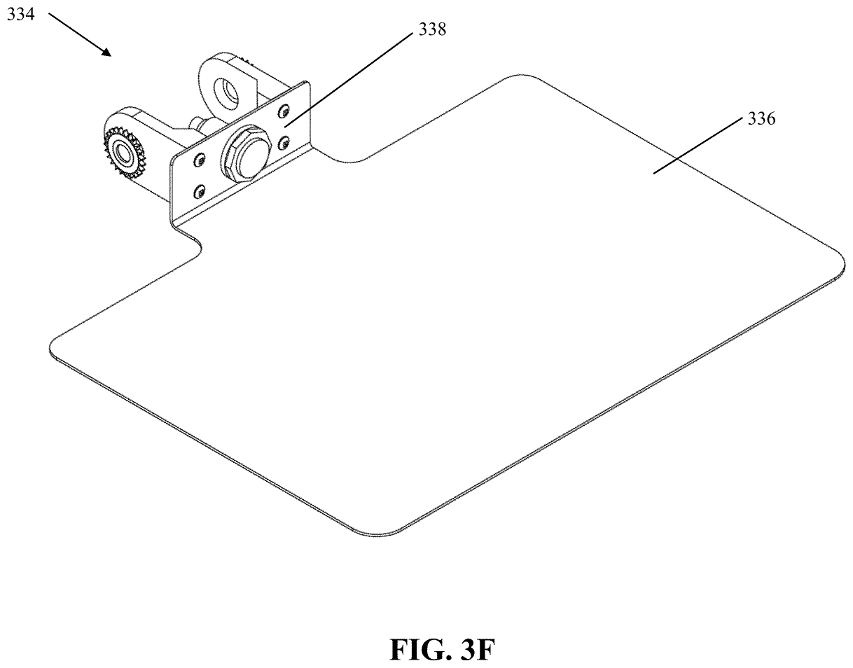

The robotic arm 118 may include a plurality of actuators that enable movement of the robotic arm 118, along a defined number of degrees of freedom, such as six degrees of freedom. The plurality of actuators may be present between two consecutively placed arm portions of a plurality of arm portions 208a-208c in the robotic arm 118. The plurality of actuators may enable movement of the plurality of arm portions 208a-208c along a defined number of degrees of freedom, such as six degrees of freedom. Alternatively, each actuator from the plurality of actuators may be a rotary actuator that may be activated separately to swivel a coupled arm portion along an axis of rotation (i.e., a roll, yaw, or a pitch) while keeping other arm portions static. The hybrid gripper 120 may be a tool, assembly, or an apparatus that may be coupled to arm portions at a free end of the robotic arm 118. The hybrid gripper 120 acts as the end effector for easy picking and lifting of the objects. Embodiments of various components of the hybrid gripper 120 are explained in detail in conjunction with FIGS. 3A-3F.

The robotic manipulator 106 may further include a movement controller that is connected to the control server 108 for receiving various commands corresponding to various actions that are to be performed by the robotic manipulator 106. The movements of the carriage 204, the robotic arm 118, and the hybrid gripper 120 are controlled by the movement controller.

FIG. 3A is a side view of the hybrid gripper 120, in accordance with an exemplary embodiment of the present disclosure. As shown in FIG. 3A, the hybrid gripper 120 includes a first end effector 302 and a second end effector 304. The first end effector 302 is pivotally coupled to the second end effector 304. As shown in FIG. 3A, the first end effector 302 includes a first longitudinal support member 306. The second end effector 304 includes a second longitudinal support member 308.

FIG. 3B is an enlarged view of a first end of the hybrid gripper 120, in accordance with an exemplary embodiment of the present disclosure. As shown in FIG. 3B, the first longitudinal support member 306 may be pivotally coupled to the second longitudinal support member 308 via a rotating frame 310. The first longitudinal support member 306 is attached to one end of the rotating frame 310. Another end of the rotating frame 310 is pivoted to the second longitudinal support member 308 via a drive assembly 312 that may be formed in a box-like shape. The drive assembly 312 has a casing that may house a servo motor. It will be apparent to a person skilled in the art that the servo motor may be coupled to the rotating frame 310 via gear box, as is known in the art. The servo motor may be controlled based on commands from the control server 108 such that the angular movement between the first end effector 302 and the second end effector 304 may be adjusted according to objects encountered in the storage area 104 and position of the objects in the storage unit 114. In an embodiment, the servo motor may be a Dynamixle servo motor. It will be apparent to a person of ordinary skill in the art that the drive assembly 312 may be actuated by one or more other mechanisms known in the art, without deviating from the scope of the disclosure.

FIG. 3C is a top view of the hybrid gripper 120, in accordance with an exemplary embodiment of the present disclosure. As shown in FIG. 3C, the first end effector 302 includes a linear actuator 313 that is attached to the first longitudinal support member 306. The linear actuator 313 includes an axle member 314 that telescopically moves in and out of the first longitudinal support member 306. In an embodiment, the first end effector 302 includes a guide plate 316 that is attached to a tip end of the first longitudinal support member 306. The guide plate 316 has first through third slots that are spaced apart from each other. The axle member 314 is movable within the second slot of the guide plate 316. The first end effector 302 further includes first and second drive shafts 318 and 320 that are movable within the first and third slots, respectively of the guide plate 316. The first and second drive shafts 318 and 320 are spaced apart from each other and extend parallel to the first longitudinal support member 306 and the axle member 314. Here, the first longitudinal support member 306 and the axle member 314 are positioned in between the first drive shaft 318 and the second drive shaft 320.

FIG. 3D is an enlarged view of a second end of the hybrid gripper 120, in accordance with an exemplary embodiment of the present disclosure. As shown in FIG. 3D, the first end effector 302 includes a gripper assembly 322 that is attached to tip ends of the axle member 314, the first drive shaft 318, and the second drive shaft 320. The linear actuator 313 provides axial movement to the gripper assembly 322. The first and second drive shafts 318 and 320 support the axle member 314 to securely hold and move the gripper assembly 322. Hence, the first and second drive shafts 318 and 320 move in alignment with the axle member 314. In an embodiment, the linear actuator 313 may be connected to a drive mechanism to move the gripper assembly 322 from a fully contracted position to a fully extended position and vice versa, or from a fully contracted position to a partially extended position and vice versa. In an embodiment, the drive mechanism is preferably pneumatically operated with a piston and an air cylinder. The piston is coupled to one end of axle member 314, and the air cylinder may be encased within or outside the first longitudinal support member 306. The pneumatically driven piston is able to control the axial movement of the axle member 314. In another embodiment, the drive mechanism may be actuated by a servo motor. The drive mechanism may be controlled based on commands from the control server 108 to control the movement of the gripper assembly 322. It will be apparent to a person of ordinary skill in the art that the drive mechanism may be actuated by one or more other mechanisms known in the art, without deviating from the scope of the disclosure. In an embodiment, the hybrid gripper 120 may include magnetic sensors in proximity to the drive mechanism so that the magnetic sensors can track the movement of the piston along longitudinal axis. The magnetic sensors may be used to detect an extend position, a retract position, and also in-between positions of the axle member 314.

FIG. 3E is an enlarged view of the gripper assembly 322, in accordance with an exemplary embodiment of the present disclosure. As shown in FIGS. 3D and 3E, the gripper assembly 322 includes a housing 324 that may encase one or more vacuum generators that may generate a vacuum, for example a vacuum pump or a venturi vacuum generator. In an embodiment, the housing 324 encases a first venturi vacuum generator and a second venturi vacuum generator that are spaced apart from each other. In the first and second venturi vacuum generators, the level of vacuum generated may be varied by adjusting pressure of compressed air being supplied. The control server 108 sends an output signal to a programmable pressure regulator to adjust the compressed air supplied to the first and second venturi vacuum generators. The first and second venturi vacuum generators include a first venturi cartridge 326a and a second venturi cartridge 326b, respectively. The gripper assembly 322 includes a first suction cup 328a and a second suction cup 328b that are connected to the first and second venturi vacuum generators, respectively. The first and second suction cups 328a-328b are in fluidic communication with the first and second venturi cartridges 326a-326b, respectively to grip and pick objects. The gripper assembly 322 may hold any number of suction cups that could be configured in different ways and/or located in different positions than specifically illustrated here as well. When the compressed air flows through the first and second venturi cartridges 326a and 326b, a negative pressure is created in the first and second venturi cartridges 326a and 326b, thereby creating suction in the first and second suction cups 328a and 328b, respectively. The created suction causes the first and second suction cups 328a and 328b to grab and pick up the objects. The compressed air may be supplied through tubes from an external source that is positioned at a base of the robotic manipulator 106.

In an embodiment, the gripper assembly 322 may include first and second vacuum sensors 329a-329b, within the housing 324, that are positioned in line between the first and second venturi cartridges 326a-326b and the first and second suction cups 328a-328b, respectively, to measure vacuum pressure of the first and second suction cups 328a and 328b, respectively. The control server 108 receives data from the first and second vacuum sensors 329a-329b to control vacuum level created within the first and second suction cups 328a and 328b, respectively.

The gripper assembly 322 may further include a camera 330 (or any other imaging device known to one of ordinary skill in the art), a first light source 332a, and a second light source 332b. The first and second light sources 332a and 332b are positioned at ends of the housing 324. The first and second light sources 332a and 332b illuminate path that the gripper assembly 322 has to move in order to pick the objects. In an embodiment, the first and second light sources 332a and 332b may be light emitting diodes (LEDs). The camera 330 is centrally mounted to the housing 324 to capture images of objects within the path and sends the images to the control server 108. The camera 330 is used to identify placement orientation of the objects to be handled during PICK and PUT operation. The control server 108 assesses the images and controls the operation of the hybrid gripper 120 or the gripper assembly 322. The control server 108 may have machine vision software to identify shapes and types of objects accurately and quickly.

Referring back to FIG. 3D, the second end effector 304 includes a spatula 334 that is rotatably coupled to an end of the second longitudinal support member 308. The spatula 334 is used to hold the objects that are loaded or picked by the gripper assembly 322.

Referring now to FIG. 3F, a perspective view of the spatula 334 of the hybrid gripper 120, in accordance with an exemplary embodiment of the present disclosure, is shown. As shown in FIG. 3F, in an embodiment, the spatula 334 may be a rigid plate 336 with round edges. Referring to FIGS. 3F and 3D, the spatula 334 has a support plate 338 that allows the spatula 334 to be rotatably coupled to the second longitudinal support member 308. The spatula 334 may be coupled to a rotating mechanism 340 to rotate the spatula 334 with respect to the second longitudinal support member 308. In an embodiment, the rotating mechanism 340 may include a server motor that is coupled to the spatula 334 via a gear box (for example, sprockets). The servo motor may be controlled based on commands from the control server 108 such that the angular movement between the spatula 334 and the second longitudinal support member 308 may be adjusted according to objects encountered in the storage area 104. The servo motor allows the spatula 334 to change its angular position with respect to the second longitudinal support member 308. It will be apparent to a person of ordinary skill in the art that the rotating mechanism 340 may be actuated by one or more other mechanisms known in the art, without deviating from the scope of the disclosure. In an embodiment, an optical sensor may be positioned on the support plate 338 of the spatula 334 to capture images of the objects placed on the spatula 334.

Referring back to FIGS. 3A and 3B, the hybrid gripper 120 includes a flange 342 that protrudes from peripheral surface of the second longitudinal support member 308. The flange 342 acts as a mating component that allows the hybrid gripper 120 to attach to the robotic arm 118. The flange 342 allows the hybrid gripper 120 to rotate along a defined number of degrees of freedom, such as six degrees of freedom with the robotic arm 118.

Referring back to FIG. 3C, in an embodiment, the guide plate 316 may be mounted with first and second optical sensors 344a and 344b to determine how to position the gripper assembly 322. It is apparent to a person skilled in the art the guide plate 316 may have only the first optical sensor 344a to capture images of surroundings to the gripper assembly 322 and the spatula 334. In an embodiment, the first and second optical sensors 344a and 344b may be communicatively coupled to the control server 108 via a wired connection or a wireless connection. The operation of the first and second optical sensors 344a and 344b may be controlled by the control server 108. The first and second optical sensors 344a and 344b capture an image of the picked object on the spatula 334, and communicate image data corresponding to the lifted object to the control server 108.

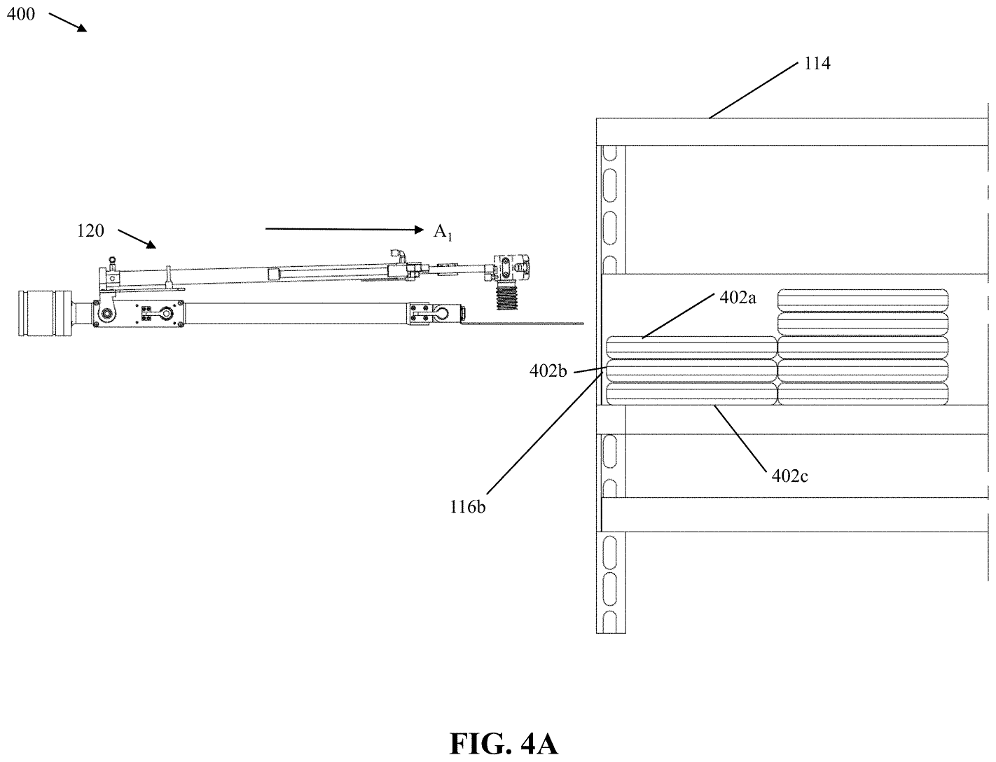

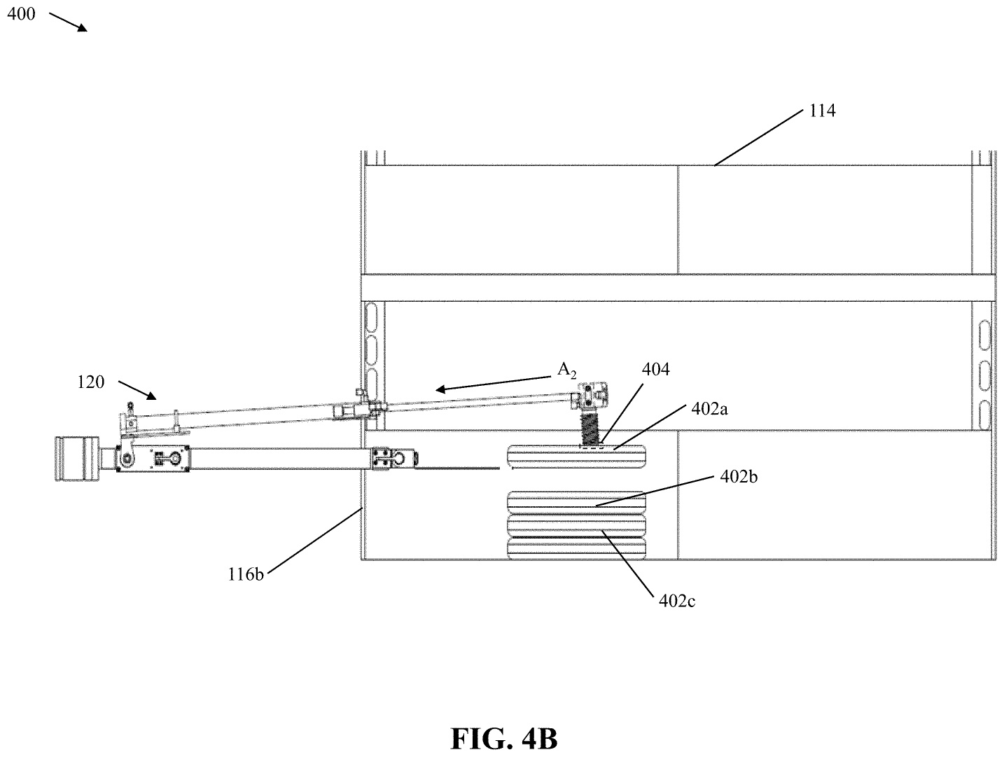

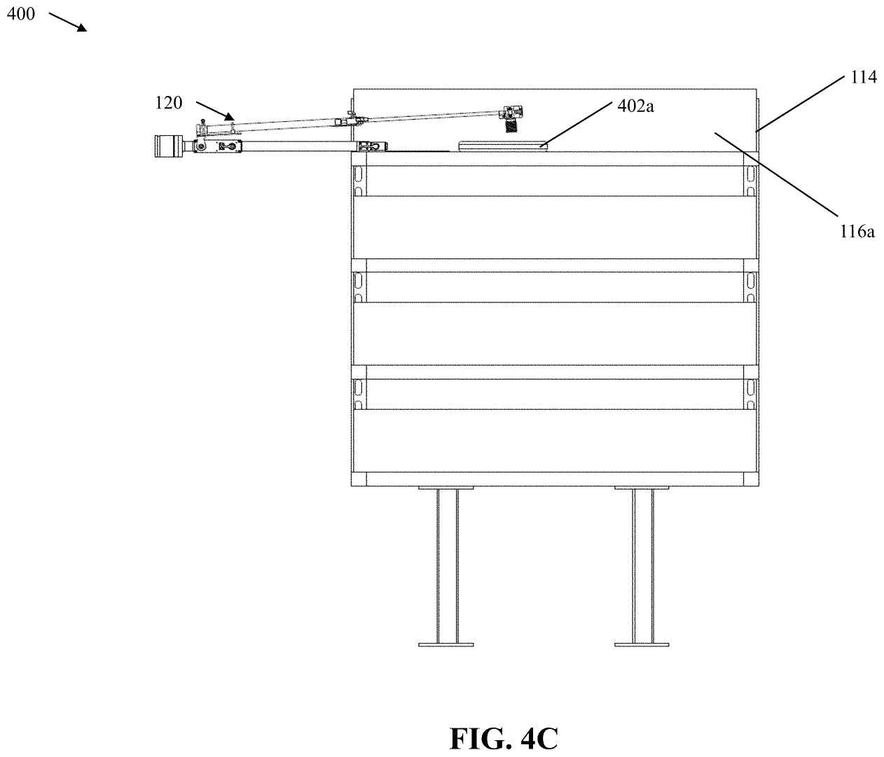

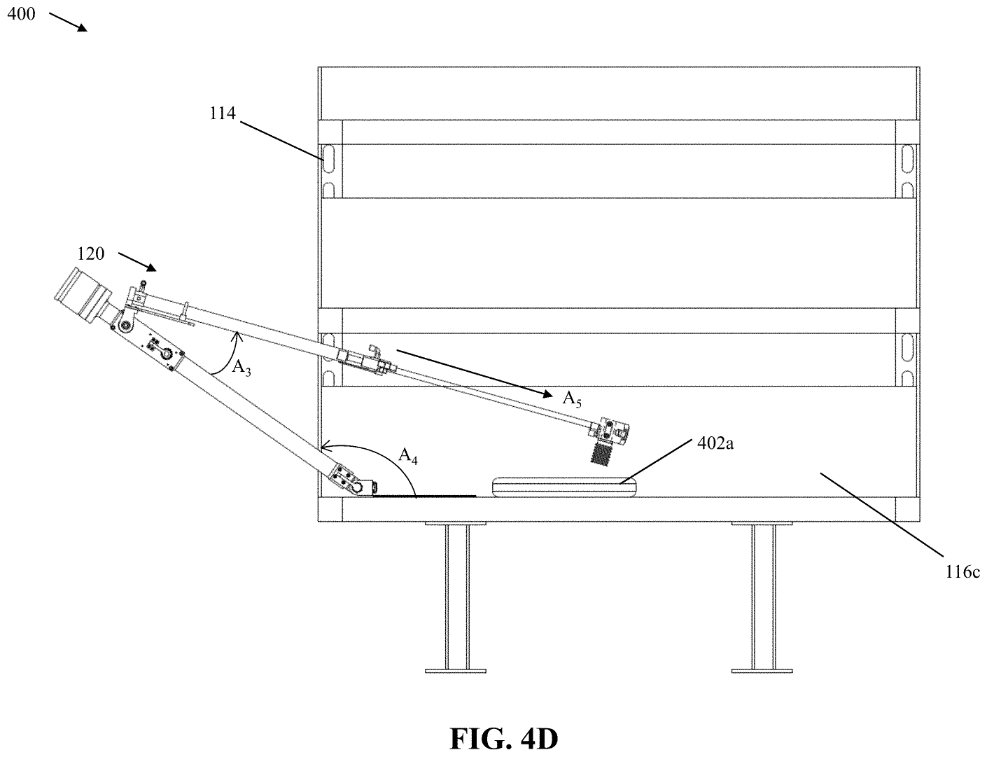

The hybrid gripper 120 may further include first and second input/output (I/O) ports for power supply and wired communication. The operation of the hybrid gripper 120 is explained in detail in conjunction with FIGS. 4A-4E.

FIGS. 4A-4E, collectively, illustrate an exemplary scenario 400 for handling an object by the hybrid gripper 120, in accordance with an exemplary embodiment of the present disclosure.

The control server 108 may receive the handling request for handling an object. The object to be handled may or may not be arranged in stack. However, for the ongoing description, it is assumed that the object is arranged in a stack. In one embodiment, the object may be on top of the stack. For the sake of brevity, it is assumed that the handling request corresponds to handling a first object 402a in a stack of objects that are arranged on the middle shelf 116b of the storage unit 114. The stack further includes second and third objects 402b and 402c that are stacked beneath the first object 402a.

The handling request may be for transporting the first object 402a from a source location in the storage facility 102 to a destination location in the storage facility 102 (e.g., another shelf of the same storage unit, a shelf of another storage unit, the operation station, or the like). The handling request includes the source and destination locations of the first object 402a, fiducial markers associated with the source and/or destination locations, and the unique identifier of the first object 402a. For the sake of brevity, it is assumed that the handling request corresponds to transporting the first object 402a from the middle shelf 116b of the storage unit 114 to the operation station.

Upon reception of the handling request, the control server 108 may use the mobile robot 107 for transporting the storage unit 114 from a first location in the storage area 104 to a second location that is within the operational range of the robotic manipulator 106 for catering to the handling request. When the storage unit 114 is transported to the second location, the control server 108 communicates the source and destination locations to the robotic manipulator 106 (i.e., the movement controller). Based on the source location, the movement controller generates and communicates various control signals to the actuators for controlling the movement of the robotic manipulator 106 such that the robotic manipulator 106 is oriented in front of the storage unit 114.

Referring now to FIG. 4A, the exemplary scenario 400 illustrates that the hybrid gripper 120 of the robotic manipulator 106 is oriented facing the storage unit 114. The hybrid gripper 120 may additionally include a scanner for scanning a tag that stores an identifier of the first object 402a. In an embodiment, the tag is attached to the first object 402a. In another embodiment, the tag is attached to the middle shelf 116b. The identifier obtained from the scanned tag is communicated to the control server 108, and the control server 108 compares the received identifier with the unique identifier of the first object 402a included in the handling request. If the two identifiers do not match, the control server 108 may communicate a first alert notification to an operator device of an operator located at the operation station. The operator may then manually search for the first object 402a in the storage facility 102, and place the first object 402a at the destination location.

If the two identifiers match, the control server 108 uses the camera 330 to determine whether the orientation of the first object 402a with respect to the remaining objects 402b and 402c is such that the first object 402a is aligned with the remaining stack (i.e., the second and third objects 402b and 402c). For the sake of brevity, it is assumed that the first object 402a is aligned with the remaining stack. The control server 108 further retrieves, from the database 110 of the control server 108, historical data (for example, physical attributes of the objects, such as shape, size, weight, number of folds, or the like and positions of the objects in the storage unit 114) associated with the first through third objects 402a-402c. When the control server 108 determines that the first object 402a is aligned with the remaining stack, the control server 108 may plan the plurality of actions to be performed by the hybrid gripper 120 to handle the first object 402a, while maintaining the original form factors of the first object 402a and the remaining stack. The control server 108 further retrieves, from the database 110 of the control server 108, historical data (for example, the physical attributes of the objects, such as shape, size, weight, number of folds, or the like and positions of the objects in the storage unit 114) associated with the first through third objects 402a-402c.

A first action in the plurality of actions may correspond to an axial movement of the gripper assembly 322 to position the first and second suction cups 328a-328b in proximity to the first object 402a. The first and second suction cups 328a-328b are then used for gripping the first object 402a from a gripping end and lifting the gripping end to a predetermined height. The gripping end is identified by the control server 108 such that the original form factors of the first object 402a and the remaining stack are maintained during the lift. In other words, the gripping end is identified by the control server 108 such that lifting the first object 402a from the gripping end does not change an appearance of the first object 402a. In one example, the gripping end is a closed end of a folded object. In another example, the gripping end is the center of the first object 402a from top.

If the control server 108 determines that the griping end of the first object 402a is on an end that is opposite to the one facing the hybrid gripper 120, the control server 108 may communicate various commands to the mobile robot 107 to rotate the storage unit 114 such that the gripping end of the first object 302a is facing the hybrid gripper 120. The control server 108 may then communicate information associated with the gripping end and a first set of commands corresponding to the first action to the robotic manipulator 106 and the hybrid gripper 120. The control server 108 may additionally communicate vacuum generation details to the hybrid gripper 120.

Referring now to FIG. 4B, the exemplary scenario 400 illustrates that under the control of the first set of commands, the movement controller may control the first end effector 302 (by communicating various control signals) to grip, by way of the first and second suction cups 328a and 328b, the gripping end 404 of the first object 402a and lift the gripping end 404 to the predetermined height. As shown in FIG. 4B, the gripping end 404, for example, is the center of the first object 402a from the top of the stack. The movement controller may control the drive assembly 312 of the rotating frame 310 and the linear actuator 313 of the axle member 314 to move the gripper assembly 322 in proximity to the first object 402a, for example, from a contracted position to a partially or fully extended position (in a direction as shown by arrow A₁). Once the gripper assembly 322 is in the proximity of the first object 402a, the first and second suction cups 328a and 328b may apply the grip force and pressure as communicated by the control server 108 to grip the gripping end 404 of the first object 402a. As the first object 402a is lifted by the first end effector 302, the first and second optical sensors 344a and 344b capture various images of the partially lifted first object 402a and the remaining stack, and communicate information corresponding to the captured images (i.e., first and second image data, respectively) to the control server 108. Based on the first and second image data and the historical data, the control server 108 identifies a gap developed between the partially lifted first object 402a and the remaining stack, and determines if the gap is equal to the predetermined height. When the control server 108 determines that the gripping end 404 is lifted to the predetermined height, the control server 108 communicates a second set of commands corresponding to a second action in the sequence of actions to the hybrid gripper 120. The second action corresponds to partially retracting the gripper assembly 322 and partially rotating the spatula 334 so that the spatula 334 is beneath the partially lifted first object 402a.

Under the control of the second set of commands, the movement controller controls the linear actuator 313 of the axle member 314 to partially retract the gripper assembly 322 (in a direction as shown by arrow A₂) and the drive assembly 312 of the rotating frame 310 to partially position the gripper assembly 322 above the spatula 334. Moreover, the movement controller controls the rotating mechanism 340 of the spatula 334 to position the spatula 334 beneath the partially lifted first object 402a.

The control server 108 uses the first and second optical sensors 344a and 344b to determine whether the first object 402a is partially positioned over the spatula 334. When the control server 108 determines that the first object 402a is partially positioned on the spatula 334, the control server 108 communicates, to the hybrid gripper 120, a third set of commands corresponding to a third action in the plurality of actions. The third action may correspond to the release of the grip of the first and second suction cups 328a and 328b on the gripping end of the first object 402a.

When the control server 108 determines that the gripping end of the first object 402a is released, the control server 108 communicates, to the hybrid gripper 120, a fourth set of commands corresponding to a fourth action in the plurality of actions. Based on the fourth set of commands, a set of pressure sensors may record the pressure exerted by the first object 402a on the spatula 334. The control server 108 determines whether the first object 402 is accurately positioned on the spatula 334 based on pressure data received from the set of pressure sensors.

When the control server 108 determines that the first object 402a is inaccurately positioned, the control server 108 may communicate a second alert notification to the operator device of the operator located at the operation station. The operator may then adjust the positioning of the first object 402a on the spatula 334, place the first object 402a back in the middle shelf 116b, or transport the first object 402a to the destination location. Alternatively, when the control server 108 determines that the first object 402a is inaccurately positioned, the hybrid gripper 120 may be controlled by the movement controller (based on various commands received from the control server 108) to place the first object 402a back in the middle shelf 116b, and to release the grip of the first and second suction cups 328a and 328b on the first object 402a.

Under the control of the third set of commands, the hold of the first and second suction cups 328a and 328b on the first object 402a has been released. Thus, the hybrid gripper 120 successfully completes the pick operation. When the first object 402a is successfully picked up, the control server 108 communicates, to the robotic manipulator 106, a fifth set of commands corresponding to a fifth action in the plurality of actions. The fifth action may correspond to transporting the picked first object 402a to the operation station.

Under the control of the fifth set of commands, the movement controller controls the robotic arm 118 to move the hybrid gripper 120 holding the first object 402a away from the middle shelf 116b. The hybrid gripper 120 may then place the first object 402a at the operation station. The control server 108 may also control the first and second end effectors 302 and 304 for placing the first object 402a at the operation station. Thus, the robotic manipulator 106 successfully completes the put-down operation, and thereby successfully handling the first object 402a. In one embodiment, to place the first object 402a at the operation station, the movement controller may adjust the hybrid gripper 120 to bring it in proximity to stack or platform on which the first object 402a has to be placed. The control server 108 may use the gripper assembly 322 to grip the first object 402a via the first and second suction cups 328a and 328b. When the gripper assembly 322 holds the first object 402a, the movement controller may control the axial and angular movements of the gripper assembly 322 and the first longitudinal support member 306, respectively, to place the first object 402a on the stack or the platform. Once the first object 402a is in on the stack, the control server 108 allows the first and second suction cups 328a and 328b to release the first object 402a on to the stack. Thus, the first object 402a is successfully transported from the middle shelf 116b to the operation station.

After the successful handling of the first object 402a, the control server 108 may store the plan information of the planned plurality of actions as feedback in the database 110 to update the historical data associated with the first object 402a and reduce the computation time during the subsequent handling of the first object 402a (or a similar object) that is arranged in a similar stack.

Referring now to FIG. 4C, the exemplary scenario 400 illustrates that the hybrid gripper 120 of the robotic manipulator 106 is oriented facing the storage unit 114. Here, the hybrid gripper 120 is used to pick objects positioned in the top shelf 116a of the storage unit 114. Referring now to FIG. 4D, the exemplary scenario 400 illustrates that the hybrid gripper 120 of the robotic manipulator 106 is oriented facing the storage unit 114. Here, the hybrid gripper 120 is used to pick objects positioned in the bottom shelf 116c of the storage unit 114. The movement controller may control the drive assembly 312 of the rotating frame 310 to provide angular movement to the first longitudinal support member 306 with respect to the second longitudinal support member 308 (in a direction as shown by arrow A₃). The movement controller may control the rotating mechanism 340 of the spatula 334 to provide angular movement to the second longitudinal support member 308 with respect to the spatula 334 (in a direction as shown by arrow A₄). Moreover, the movement controller may control the linear actuator 313 to provide axial movement to the gripper assembly 322 (in a direction as shown by arrow A₅). Thus, the control server 108 would be easily able to handle objects held in the bottom shelf 116c with the hybrid gripper 120.

It will be apparent to a person skilled in the art that an object may be transported from a stack arranged on a shelf of a storage unit to another shelf of the same storage unit or from a stack arranged on a shelf of one storage unit to a shelf of another storage unit in a similar manner as described above for transporting the first object 402a as described above. Further, an object may be transported from a stack arranged at the operation station to a shelf of a storage unit in a similar manner as described above for transporting the first object 402a. Further, when the handling corresponds to adjusting the alignment of the first object 402a in the middle shelf 116b, the first object 402a may be lifted by the hybrid gripper 120 that is oriented parallel to the alignment of the first object 402a. Upon lifting, the orientation of the hybrid gripper 120 may be adjusted such that the spatula 334 is parallel to the remaining stack. The hybrid gripper 120 may then put-down the first object 402a on top of the second object 402b. The first object 402a is lifted and put-down in a similar manner as described above. In such a scenario, the source and destination locations are the same (i.e., the middle shelf 116b). Additionally, when the handling corresponds to the transport of an object that is misaligned in the stack, the hybrid gripper 120 may lift the misaligned object in the afore-mentioned manner, and put-down the lifted object at the destination location.

The control server 108 may be further configured to determine a first distance that the gripper assembly 322 has to be moved with respect to the first longitudinal support member 306 to achieve the axial movement shown by arrow A₅. The first distance may correspond to a partially extended position or a fully extended position of the gripper assembly 322. The control server 108 may be further configured to determine a first angle that the first longitudinal support member 306 has to be moved with respect to the second longitudinal support member 308 to achieve the angular movement in the direction as shown by arrow A₃. The first angle may be a fully rotated position or a partially rotated position of the first longitudinal support member 306 with respect to the second longitudinal support member 308. The control server 108 may be further configured to determine a second angle that the spatula 334 has to be moved with respect to the second longitudinal support member 308 to achieve the angular movement of the second longitudinal support member 308 with respect to the spatula 334 in the direction as shown by arrow A₄. The second angle may be a fully rotated position or a partially rotated position of the second longitudinal support member 308 with respect to the spatula 334. The control server 108 may be configured to determine the first distance, the first angle, and the second angle based on at least one of height at which the object is positioned, a depth of storage of the object, and the physical attributes of the object. For example, the control server 108 may use different combinations of values of the first distance, the first angle, and the second angle to handle objects with varying dimensions and stored at different heights in the storage unit 114. The control server 108 controls the hybrid gripper 120 by varying the values of the first distance, the first angle, and the second angle such that hybrid gripper 120 can handle objects of different physical attributes and that are positioned at different heights in the storage unit 114. Hence, the hybrid gripper 120 is used to handle objects seamlessly from lower and upper bins or shelves in any storage unit. The information pertaining to the determined first distance, the first angle, and the first height is communicated by the control server 108 to the robotic manipulator 106 via corresponding commands.

In an embodiment, while handling the object by the hybrid gripper 120, the spatula 334 is positioned parallel to surface of bin or shelf of the storage unit 314. Depending on physical attributes such as shape, size, weight, number of folds, or the like of the object, the gripper assembly 322 has to position itself at a specific angle such that the gripper assembly 322 can grip the object on its top end. The positioning of the gripper assembly 322 at the specific angle can be achieved only by providing the angular movement between the spatula 334 and the second longitudinal support member 308 and the angular movement between the first longitudinal support member 306 and the second longitudinal support member 308. Similarly, the positioning of the gripper assembly 322 at different heights in the storage unit 314 can be achieved only by providing the angular movement between the spatula 334 and the second longitudinal support member 308 and the angular movement between the first longitudinal support member 306 and the second longitudinal support member 308.

Although FIGS. 1 and 4A-4D describe a GTP setup, the scope of the present disclosure is not limited to it. In various other embodiments, the control server 108 may be configured to implement a person-to-goods (PTG) setup in the storage facility 102, where the robotic manipulator 106 is moved to the first location of the storage unit 114 for executing the pick operation, and then to the destination location (e.g., the operation station) for executing the put-down operation.

FIG. 5 is a block diagram that illustrates the control server 108, in accordance with an exemplary embodiment of the present disclosure. In some embodiments, the control server 108 may include processing circuitry 502, a memory 504, and a transceiver 506 that communicate with each other by way of a communication bus 508. The processing circuitry 502 may include an inventory manager 510, a request handler 512, an image processor 514, an action planner 516, and a command handler 518. It will be apparent to a person having ordinary skill in the art that the control server 108 is for illustrative purposes and not limited to any specific combination or hardware circuitry and/or software.

The processing circuitry 502 executes various operations, such as inventory or warehouse management operations, procurement operations, or the like. The processing circuitry 502 executes the inventory management operations, such as planning the sequence of actions to be performed by the robotic manipulator 106 for handling objects (as described in the foregoing descriptions of FIGS. 4A-4D) and to facilitate transport of the objects while maintaining the corresponding original form factor. The processing circuitry 502 executes the inventory or warehouse management operations by way of the inventory manager 510, the request handler 512, the image processor 514, the action planner 516, and the command handler 518.

The inventory manager 510 includes suitable logic, instructions, circuitry, interfaces, and/or code for managing an inventory list that includes a list of objects stored in the storage facility 102, a number of units of each object stored in the storage facility 102, and a source location (i.e., a shelf and/or a storage unit) where each object is stored. For example, the inventory manager 510 may add new objects to the inventory list when the new objects are stored in the storage area 104 and may update the inventory list whenever there is any change in regards to the objects stored in the storage area 104 (e.g., when items are retrieved from the storage unit 114 for fulfilment of orders).

The request handler 512 includes suitable logic, instructions, circuitry, interfaces, and/or code for processing all handling requests received by the control server 108. The request handler 512 may identify objects pertinent to the handling requests, and the shelves 116a-116c that store the objects associated with the handling requests. The request handler 512 may further communicate, for fulfilment of the handling requests, details regarding the objects (such as the source location, the destination location, the fiducial markers, the unique identifiers, or the like) to the robotic manipulator 106. Additionally, the request handler 512 may merge various handling requests when objects to be handled are stored in the same storage unit.

The image processor 514 includes suitable logic, instructions, circuitry, interfaces, and/or code for receiving the first and second image data from the first and second optical sensor 344a and 344b. By utilizing one or more image processing techniques on the first and second image data, the image processor 514 detects length of the first object 402a that is positioned on the spatula 334 and identifies the gripping end 404 of the first object 402a that is to be handled. The image processor 514 further identifies the gap developed between the partially lifted first object 402a and the remaining middle shelf 116b, and determines if the gap is equal to the predetermined height (i.e., whether the gripping end 404 is lifted to the predetermined height).

The action planner 516 includes suitable logic, instructions, circuitry, interfaces, and/or code for planning various actions to be performed by the robotic manipulator 106 and the hybrid gripper 120. For example, the action planner 516 may plan the plurality of actions to be performed by the robotic manipulator 106 and the hybrid gripper 120 to handle the first object 402a while maintaining the original form factors of the first object 402a. The control server 108 may plan the sequence of actions in real-time based on data of the first object 402a that is to be handled, and the historical data. The action planner 516 also executes various other operations such as determining whether the orientation of the first object 402a with respect to the remaining stack is such that the first object 402a is aligned with the remaining stack, determining whether the first object 402a is accurately positioned on the spatula 334, generating the first through second alert notifications, or the like. The action planner 516 may further store the planned sequence of actions in the memory 504 or the database 110 for future use, e.g., handling the second and third objects 402b and 402c in the middle shelf 116b. The action planner 516 may be further configured to determine optimal values for the first distance, the first angle, and the second angle to handle objects stored at different heights.

The command handler 518 includes suitable logic, instructions, circuitry, interfaces, and/or code for generating various commands corresponding to the actions planned by the action planner 516. For example, the command handler 518 generates the first through fifth sets of commands corresponding to the first through fifth actions in the plurality of actions, respectively.

Examples of the inventory manager 510, the request handler 512, the image processor 514, the action planner 516, and the command handler 518 may include, but are not limited to, an application-specific integrated circuit (ASIC) processor, a reduced instruction set computing (RISC) processor, a complex instruction set computing (CISC) processor, a field-programmable gate array (FPGA), a microcontroller, a combination of a central processing unit (CPU) and a graphics processing unit (GPU), or the like.

The memory 504 includes suitable logic, instructions, circuitry, interfaces to store one or more instructions that are executed by the inventory manager 510, the request handler 512, the image processor 514, the action planner 516, and the command handler 518 for performing one or more operations. Additionally, the memory 504 may store the inventory list, the map or the layout of the storage facility 102, or the like. In one embodiment, the information stored in the database 110 may be stored in the memory 504, without deviating from the scope of the disclosure. Examples of the memory 504 may include a RAM, a ROM, a removable storage drive, an HDD, a flash memory, a solid-state memory, and the like.

The transceiver 506 transmits and receives data over the communication network 112 using one or more communication network protocols. The transceiver 506 may transmit various messages and commands to the robotic manipulator 106 and the hybrid gripper 120 and receive data from the first and second optical sensors 344a and 344b. Examples of the transceiver 506 may include, but are not limited to, an antenna, a radio frequency transceiver, a wireless transceiver, a Bluetooth transceiver, an ethernet based transceiver, a universal serial bus (USB) transceiver, or any other device configured to transmit and receive data.

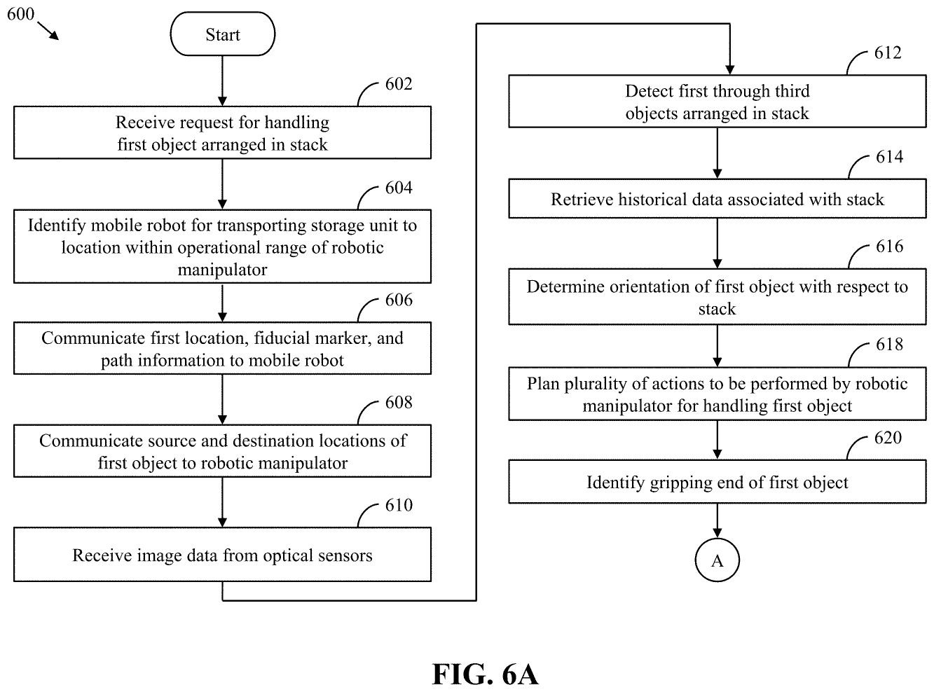

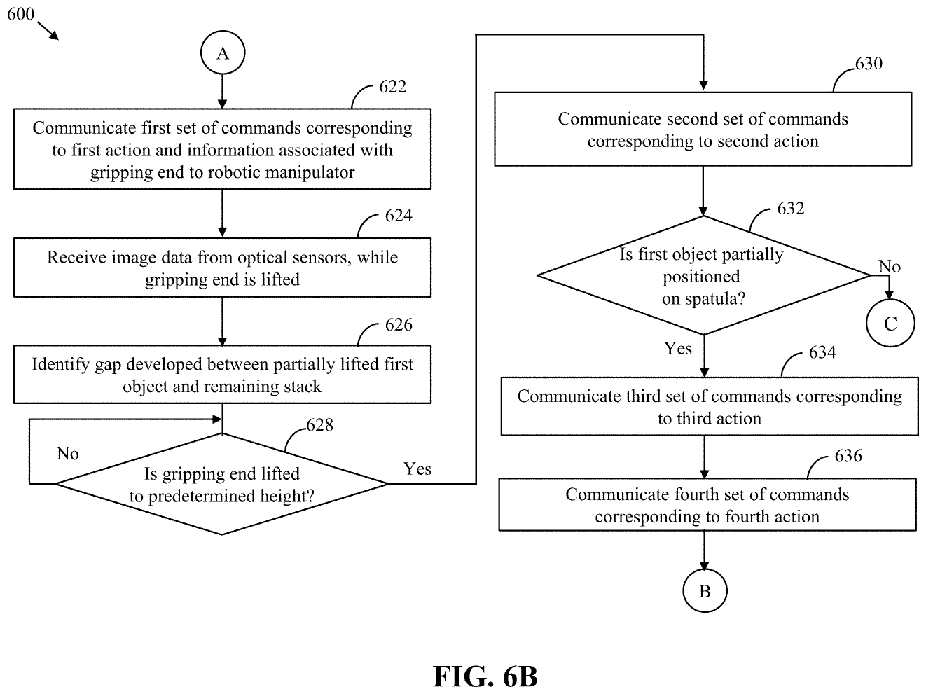

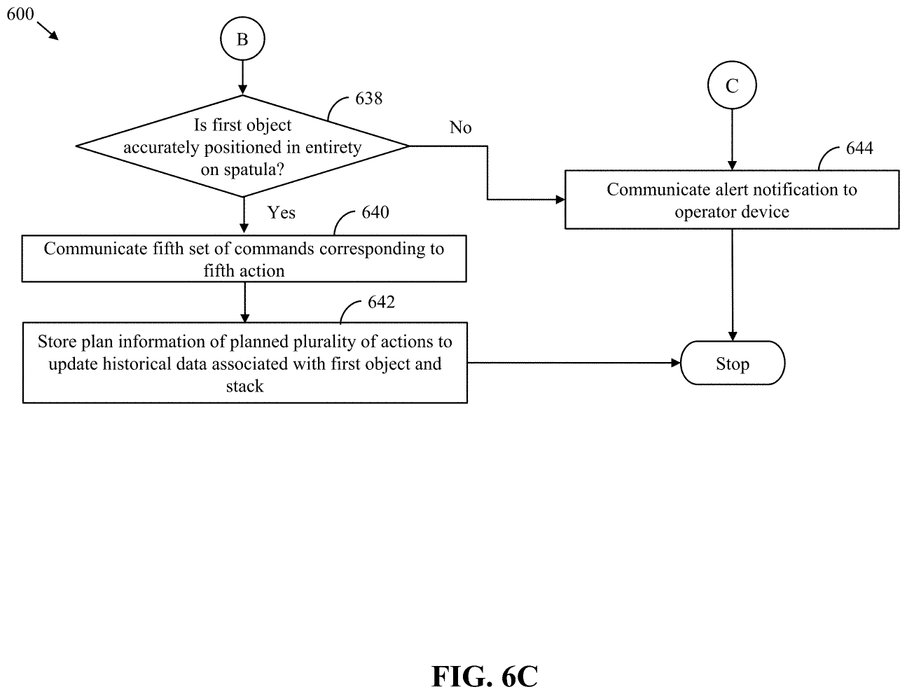

FIGS. 6A-6C, collectively represent a flow chart 600 that illustrates a process (i.e., a method) for handling an object arranged in a stack at a first height in a storage unit 114, in accordance with an exemplary embodiment of the disclosure. Referring now to FIG. 6A, the process may generally start at step 602, where the control server 108 may receive the handling request for handling the object that is arranged in a stack. In one embodiment, the object is on top of the stack. For the sake of brevity, it is assumed that the handling request corresponds to transporting the first object 402a (shown in FIGS. 4A-4D) arranged on the second shelf 116b of the storage unit 114 to the operation station. Thus, the handling request includes the source location as the second shelf 116b, the destination location as the operation station, the fiducial marker of the second shelf 116b, and the unique identifier of the first object 402a.

The process proceeds to step 604, where the control server 108 may identify the mobile robot 107 for transporting the storage unit 114 from the first location in the storage area 104 to the second location that is within the operational range of the robotic manipulator 106 for catering to the handling request. The identification of the mobile robot 107 may be based on an availability of the mobile robot 107, a proximity of the mobile robot 107 to the storage unit 114, or the like. The process proceeds to step 606, where the control server 108 communicates, to the mobile robot 107, the first location of the storage unit 114, the fiducial marker of the storage unit 114, and a path information of various paths to be followed by the mobile robot 107 to reach the first location from the current location, and from the first location to the second location. The mobile robot 107 may then approach the first location, lift the storage unit 114, and transport the storage unit 114 from the storage area 104 to the second location that is within the operational range of the robotic manipulator 106.

The process proceeds to step 608, where the control server 108 communicates the source and destination locations of the first object 402a to the robotic manipulator 106, for example, the movement controller, when the storage unit 114 is transported to the second location. Based on the source location, the movement controller generates and communicates various control signals to the actuators for controlling the movement of the robotic manipulator 106 such that the robotic manipulator 106 is oriented to face the storage unit 114.

The process proceeds to step 610, where the control server 108 receives image data from the first and second optical sensors 344a and 344b. The process proceeds to step 612, where based on the image data, the control server 108 detects the first through third objects 402a-402c arranged in the stack in the second shelf 116b.

The process proceeds to step 614, where the control server 108 retrieves the historical data associated with the stack. The control server 108 retrieves, from the database 110, historical data (physical attributes of the objects, such as shape, size, weight, number of folds, or the like and position information of the objects) associated with the first through third objects 402a-402c. The process proceeds to step 616, where the control server 108 determines the orientation of the first object 402a with respect to the stack. The process proceeds to step 618, where the control server 108 plans the sequence of actions (i.e., the sequence of the plurality of actions) to be performed by the robotic manipulator 106 for handling the first object 402a. The process proceeds to step 620, where the control server 108 identifies the gripping end 404 of the first object 402a. The process then proceeds to process A as shown in FIG. 6B.

Referring now to FIG. 6B, the process A proceeds to step 622, where the control server 108 communicates the first set of commands corresponding to the first action and information associated with the gripping end 404 to the robotic manipulator 106. The process then proceeds to step 624, where the control server 108 receives image data from the first and second optical sensors 344a and 344b, while the gripping end 404 is lifted by the gripper assembly 322. The process proceeds to step 626, where the control server 108 identifies the gap between the partially lifted first object 402a and the remaining stack. The process proceeds to step 628, where the control server 108 determines whether the gripping end 404 is lifted to the predetermined height (i.e., whether the gap is equal to the predetermined height). If at step 628, the control server 108 determines that the gripping end 404 is lifted to the predetermined height, the process proceeds to step 630. If at step 628, the control server 108 determines that the gripping end 404 is not lifted to the predetermined height, the height of the gripping end 404 is adjusted and step 628 is repeated until the gripping end 404 is lifted to the predetermined height. At step 630, the control server 108 communicates the second set of commands corresponding to the second action to the robotic manipulator 106. The second action corresponds to controlling the linear actuator 313 of the axle member 314 to partially retract the gripper assembly 322 and controlling the drive assembly 312 of the rotating frame 310 to partially position the gripper assembly 322 above the spatula 334. Moreover, the second action corresponds to controlling the rotating mechanism 340 of the spatula 334 to position the spatula 334 beneath the partially lifted first object 402a. The process proceeds to step 632, where the control server 108 determines whether the first object 402a is partially placed on the spatula 334. If at step 632, the control server 108 determines that the first object 402a is partially placed on the spatula 334, the process proceeds to step 634. The process proceeds to step 634, where the control server 108 communicates the third set of commands corresponding to the third action to the robotic manipulator 106. The third action may correspond to the release of the grip of the first and second suction cups 328a and 328b on the gripping end 404. Based on the third set of commands, the control server 108 controls the first and second suction cups 328a and 328b to release the grip on the gripping end 404.

At step 636, the control server 108 communicates the fourth set of commands corresponding to the fourth action to the robotic manipulator 106. The fourth action may correspond to recording the pressure exerted by the first object 402a on the spatula 334 by the set of pressure sensors. The process then proceeds to process B as shown in FIG. 6C.

Referring now to FIG. 6C, the process B proceeds to step 638, the control server 108 determines whether the first object 402 is accurately positioned in entirety on the spatula 334, the process proceeds to step 640. At step 640, the control server 108 communicates the fifth set of commands corresponding to the fifth action to the robotic manipulator 106. The fifth action may correspond to moving the hybrid gripper 120 holding the first object 402a away from the middle shelf 116b and transporting the picked first object 402a to the operation station. The process proceeds to step 642, where the control server 108 stores the plan information of the determined sequence of actions in the database 110 to update the historical data associated with the first object 402a and the corresponding stack, and reduce the computation time during the subsequent handling of the first object 402a (or a similar object) that is arranged in a similar stack.

If at step 638, the control server 108 determines that the first object 402a is partially placed on the spatula 334, the process proceeds to step 644. If at step 638, the control server 108 determines that the first object 402a is not accurately positioned in entirety on the spatula 334, the process proceeds to step 644. At 644, the control server 108 communicates alert notification to an operator device of the operator. Based on the alert notification, the operator may correct the placement or orientation of the first object 402a on the spatula 334.

Techniques consistent with the present disclosure provide, among other features a method and system for handling one or more objects arranged in a stack. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the width or scope.

According to some embodiments, the hybrid gripper 120 utilizes the angular movement of the first longitudinal support member 306 and the spatula 334 and the axial movement of the gripper assembly 322 to ensure that the form factor of the first object 402a is maintained during the handling of the first object 402a (i.e., during the pick-up, the transport, and/or the placement) and to reach objects that are positioned at different heights in the storage unit 114. Further, the use of the hybrid gripper 120 ensures that the robotic manipulator 106 may be used to pick objects in the various shelves of the storage unit 114. The control server 108 may store the planned plurality of actions in the database 110 and re-use the stored plurality of actions for handling other objects in a similar manner, thereby reducing the time required for handling the objects in the storage facility 102. Thus, the handling of the objects as described in the disclosure is more efficient as compared to other known object handling methods. The hybrid gripper 120 provides more degrees of freedom to achieve ease in operation of handling the objects.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A robotic apparatus comprising:
a robotic arm; and
a hybrid gripper coupled to the robotic arm, wherein a movement of the robotic arm orients the hybrid gripper with respect to an object positioned at a first height of a plurality of heights, wherein the hybrid gripper includes:
a first end effector that has (i) a first longitudinal support member, (ii) a gripper assembly, and (iii) a linear actuator attached to the first longitudinal support member and the gripper assembly, wherein the linear actuator provides an axial movement of the gripper assembly with respect to the first longitudinal support member, and wherein the gripper assembly grips and picks the object positioned at the first height;
a second end effector pivotably coupled to the first end effector, wherein the second end effector includes a second longitudinal support member and a spatula, rotatably coupled to an end of the second longitudinal support member, to hold the object picked by the gripper assembly;
a drive assembly coupled to the first longitudinal support member and the second longitudinal support member, the drive assembly configured to move the first longitudinal support member with respect to the second longitudinal support member in a first angular movement; and
a rotating mechanism coupled to the second longitudinal support member and the spatula, the rotating mechanism configured to move the spatula with respect to the second longitudinal support member in a second angular movement.

2. The robotic apparatus of claim 1, wherein the first end effector further comprises a guide plate attached to a tip end of the first longitudinal support member to support the linear actuator.

3. The robotic apparatus of claim 2, wherein the first end effector further comprises a first drive shaft and a second drive shaft that are attached to the gripper assembly and move through the guide plate.

4. The robotic apparatus of claim 2, wherein the linear actuator comprises an axle member that moves through the guide plate and moves in and out of the first longitudinal support member.

5. The robotic apparatus of claim 1, wherein the gripper assembly comprises a housing and at least one suction cup that is coupled to the housing to grip and pick the object.

6. The robotic apparatus of claim 5, wherein the gripper assembly further comprises at least one venturi cartridge that is in communication with at least one suction cup to provide negative pressure to the at least one suction cup to grip and pick the object.

7. The robotic apparatus of claim 1, wherein the hybrid gripper further comprises a flange that extends from the second longitudinal member and coupled to the robotic arm, wherein the robotic arm rotates the hybrid gripper along a defined number of degrees of freedom.

8. The robotic apparatus of claim 1, wherein the first end effector further comprises a camera that is mounted on the gripper assembly to capture images of the object within a path of the gripper assembly.

9. The robotic apparatus of claim 1, wherein the first end effector further comprises at least one light source to illuminate a path that the gripper assembly has to move to pick the object.

10. The robotic apparatus of claim 1, wherein the hybrid gripper further comprises a rotating frame that is attached to the first longitudinal support member and the second longitudinal support member to allow the first longitudinal member to rotate with respect to the second longitudinal member.

11. A system for object handling in a storage facility, the system comprising:
a robotic apparatus, including:
a robotic arm; and
a hybrid gripper coupled to the robotic arm, wherein the hybrid gripper comprises:
a first end effector that has (i) a first longitudinal support member, (ii) a gripper assembly, and (iii) a linear actuator attached to the first longitudinal support member and the gripper assembly, wherein the linear actuator provides an axial movement of the gripper assembly with respect to the first longitudinal support member;
a second end effector pivotably coupled to the first end effector, wherein the second end effector includes a second longitudinal support member and a spatula, rotatably coupled to an end of the second longitudinal support member, to hold the object picked by the gripper assembly;
a drive assembly coupled to the first longitudinal support member and the second longitudinal support member, the drive assembly configured to move the first longitudinal support member with respect to the second longitudinal support member inf a first angular movement; and
a rotating mechanism coupled to the second longitudinal support member and the spatula, the rotation member configured to move the spatula with respect to the second longitudinal support member in a second angular movement; and
a control server in communication with the robotic apparatus, the control server configured to:
detect an object of the plurality of objects to be handled;
determine a plurality of actions to be performed by the robotic apparatus for handling the object; and
control, based on the determined plurality of actions:
the robotic arm to orient the hybrid gripper with respect to the object positioned at a first height;
the linear actuator to move the gripper assembly by a first distance from an end of the first longitudinal support member;
the drive assembly to rotate the first longitudinal support member to a first angle with respect to the second longitudinal support member;
the rotating mechanism to rotate the spatula to a second angle with respect to the second longitudinal support member; and
the gripper assembly to grip and pick the object from the first height and place the picked object on the spatula.

12. The system of claim 11, further comprising a database associated with the control server, wherein the control server is further configured to store, upon successful handling of the object, the plurality of actions in the database.

13. The system of claim 11, wherein the control server is further configured to determine the plurality of actions based on historical data associated with the object and position of the object in a storage unit, wherein the historical data includes at least one of a set of physical attributes of the object and information associated with previous handling of the object.

14. The system of claim 11, wherein the control server is configured to determine the first distance, the first angle, and the second angle based on at least one of the first height at which the object is positioned and a set of physical attributes of the object.

15. The system of claim 11, wherein the first end effector further comprises:
a guide plate attached to a tip end of the first longitudinal support member;
a first drive shaft and a second drive shaft that are attached to the gripper assembly and move through the guide plate, wherein the linear actuator comprises an axle member that moves through the guide plate and moves in and out of the first longitudinal support member; and
a camera that is mounted on the gripper assembly to capture images of the object within a path of the gripper assembly.

16. The system of claim 11, wherein the hybrid gripper further comprises a flange that extends from the second longitudinal support member and coupled to the robotic arm, wherein the robotic arm rotates the hybrid gripper along a defined number of degrees of freedom.

17. The system of claim 11, wherein the gripper assembly comprises:
a housing;
at least one venturi cartridge encased in the housing; and
at least one suction cup that is in communication with the at least one venturi cartridge to generate negative pressure to grip and pick the object.

18. The system of claim 11, further comprising:
a storage unit that has a plurality of shelves, wherein the object is arranged in a stack of a plurality of objects on a first shelf of the plurality of shelves; and
a mobile robot that is configured to transport to the storage unit from a first location to a second location that is within an operational range of the robotic manipulator.
